(19) United States
(12) Patent Application Publication
(10) Pub. No.: US 2007/0005592 A1
(43) Pub. Date: Jan. 4, 2007

(54) Computer-implemented method, system, and program product for evaluating annotations to content

(75) Inventors: John R. Kender, Leonia, NJ (US); Milind R. Naphade, Fishkill, NY (US)

Correspondence Address: HOFFMAN, WARNICK & D'ALESSANDRO LLC, 75 State Street, 14th Floor, ALBANY, NY, 12207, US

(73) Assignee: International Business Machines Corporation, Armonk, NY (US)

(21) Appl. No.: 11/158,223

(22) Filed: Jun. 21, 2005

(51) Int. Cl. G06F 17/30

(52) U.S. Cl. 707/6

(57) ABSTRACT

A method, system and program product for evaluating annotations to content are described. Under aspects of the present invention, annotations made to content are received and evaluated for accuracy. Each annotation typically includes at least one element (e.g., terms) describing the content. The evaluation includes a syntactic level evaluation and at least one of a semantic level evaluation, a source level evaluation, a content level evaluation, or an annotator level evaluation. Based on the evaluations, feedback can be provided to an annotator making the annotations.

### CROSS-REFERENCE TO RELATED APPLICATIONS

This application is related in some aspects to the commonly assigned application entitled “Computer-Implemented Method, System, and Program Product For Tracking Content” that was filed on Jun. 16, 2005, and is assigned attorney docket number YOR920050294US1 and serial number (will be provided), the entire contents of which are hereby incorporated by reference. This application is also related in some aspects to the commonly assigned application entitled “Computer-Implemented Method, System, and Program Product For Developing a Content Annotation Lexicon” that was filed on (will be provided), and is assigned attorney docket number YOR920050250US1 and serial number (will be provided), the entire contents of which are hereby incorporated by reference.

### STATEMENT OF GOVERNMENT RIGHTS

This invention was made with Government support under Contract 2004 H839800 000 awarded by (will be provided). The Government has certain rights in this invention.

### BACKGROUND OF THE INVENTION

1. Field of the Invention

The present invention generally relates to content annotation validation. Specifically, the present invention relates to a method, system and program product for evaluating annotations to content.

2. Related Art

Content indexing/annotation is rapidly becoming a valuable resource in tracking and managing content (e.g., video broadcasts, audio broadcasts, Internet content, electronic mail messages, etc.). To annotate content, annotators (known in the art as Ontologists) attach descriptive terms or concepts to segments of the content. Unfortunately, because there are few crisp theories for content annotation, almost all of the annotation research collected to date has depended on the collection of human annotations. However, this body of knowledge grows slowly and has been found to be quite error prone.

There are currently extremely primitive tools for assisting annotators. There is not even agreement as to what units should be annotated: a single frame, a single shot, an entire broadcast/episode, etc. Additionally, the terms used to annotate these units are not well-understood or well-organized (e.g., the ontologies used for the annotations are not necessarily derived from the underlying semantics of the domain). For example, for news video content, the names of people and countries often dominate the annotation, even though it is their roles that should be emphasized. Likewise, graphics and visualizations are captured by simply naming them rather than categorizing them by their functions, such as economic, political, weather-related, etc. Thus, without computer assistance, annotation tends to be a highly idiosyncratic task, with different annotators favoring different terms and different emphases. What should result in uniform ground truth unfortunately tends to become an unstable mixture of personal preferences. Even the few most advanced tools work paradoxically in this direction in that they try to assist the annotator by repeating in future annotations the expressed preferences of the annotator in the past. However, this approach only accentuates inter-annotator biases and disagreements.

In addition, existing approaches neither monitor nor restrict annotator activities. Consequently, there is no quality control. In fact, there is often the opposite in that systems allow any prior annotation, however faulty, to be propagated across fresh data, thus reinforcing errors. There are also no safeguards to guarantee that an annotation is complete: entire concepts can be fully ignored without system complaint. For example, although nearly all video shots have a central actor or object, a central activity or event, and a central physical location or setting, current systems allow the omission of any or all of these critical concepts. Ironically, the most popular concepts are the ones most taken for granted and therefore most omitted by annotators. For example, the inadvertent omission of concepts such as “people” or “studio_setting” result in the false impression that a given video unit does not include these important concepts. No annotations are checked. Nor are critical choices presented in a forced, select-one-of manner.

Still yet, even a complete annotation can be wrong in substantial ways. Typographic or mouse errors can result in radically erroneous annotations (e.g., “outer-space” rather than “outdoors”) whose content is obviously at odds with the data. Even simple spelling errors have the unfortunate effect of suggesting a new concept, for example, “Saddam” and “Sadam” are considered to be different objects. If the tool allows annotators to create new concepts, those new concepts are not checked against existing ones, nor are they even monitored against any rules for good formation. Consequently, inappropriately specific concepts such as “person_cooking_ham_and_eggs” and “person_putting_ketchup_on_breakfast” are considered legitimate peers to concepts like “walking” or “frowning”.

In short, current annotation approaches fail to provide any consistency between annotators, or any checking of annotations for accuracy or appropriateness.

### SUMMARY OF THE INVENTION

In general, the present invention provides a computer-implemented method, system and program product for evaluating annotations to content. Specifically, under the present invention, annotations made to content are received and evaluated for accuracy and appropriateness. Each annotation typically includes at least one element (e.g., concepts or terms) describing the content. The evaluation of an annotation includes a syntactic level evaluation and at least one of a semantic level evaluation, a source level evaluation, a content level evaluation, or an annotator level evaluation. The syntactic level evaluation determines, among other things, whether the annotation includes a required element based on a context of the content, checks a spelling of the element(s) in each annotation, and determines whether the element(s) in each annotation meets a length requirement. The semantic level evaluation determines, among other things, whether the element(s) in annotations meets an expected frequency of use, and determines whether any groupings of the element(s) in each annotation are commonly used together. The source level evaluation determines, among other things, whether the element(s) in each annotation matches a temporal setting (e.g., seasonality, shelf-life, etc.) of the content, and determines whether the element(s) in each annotation is reflective of a provider of the content. The content level evaluation, among other things, identifies similar pieces of content under the premise that similar content should have similar annotations. The annotator level evaluation, among other things, “learns” individual behavior and idiosyncratic preferences to for future evaluations. Based on these one or more evaluations being performed, feedback can be provided to the annotator making the annotations, and/or used to update a knowledge base of data that is referenced in making the annotations.

A first aspect of the present invention provides a computer-implemented method for evaluating annotations to content, comprising: receiving a set of annotations for content, wherein each of the set of annotations includes at least one element that describes the content; performing a syntactic level evaluation and at least one of a semantic level evaluation, a source level evaluation, a content level evaluation, or an annotator level evaluation to determine accuracy of the set of annotations; and providing feedback based on the evaluations.

A second aspect of the present invention provides a system for evaluating annotations to content, comprising: an annotation reception system configured to receive a set of annotations for content, wherein each of the set of annotations includes at least one element that describes the content; an annotation evaluation system configured to perform a syntactic level evaluation and at least one of a semantic level evaluation, a source level evaluation, a content level evaluation, or an annotator level evaluation to determine accuracy of the set of annotations; and a feedback system configured to provide feedback based on the evaluations.

A third aspect of the present invention provides a program product stored on a computer useable medium for evaluating annotations to content, the program product comprising program code for causing a computer system to perform the following steps: receiving a set of annotations for content, wherein each of the set of annotations includes at least one element that describes the content; performing a syntactic level evaluation and at least one of a semantic level evaluation, a source level evaluation, a content level evaluation, or an annotator level evaluation to determine accuracy of the set of annotations; and providing feedback based on the evaluations.

A fourth aspect of the present invention provides a method for deploying an application for evaluating annotations to content, comprising: providing a computer infrastructure being operable to: receive a set of annotations for content, wherein each of the set of annotations includes at least one element that describes the content; perform a syntactic level evaluation and at least one of a semantic level evaluation, a source level evaluation, a content level evaluation, or an annotator level evaluation to determine accuracy of the set of annotations; and provide feedback based on the evaluations.

A fifth aspect of the present invention provides computer software embodied in a propagated signal for evaluating annotations to content, the computer software comprising instructions for causing a computer system to perform the following functions: receive a set of annotations for content, wherein each of the set of annotations includes at least one element that describes the content; performing a syntactic level evaluation and at least one of a semantic level evaluation, a source level evaluation, a content level evaluation, or an annotator level evaluation to determine accuracy of the set of annotations; and provide feedback based on the evaluations.

Therefore, the present invention provides a computer-implemented method, system and program product for evaluating annotations to content.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for evaluating annotations to content according to the present invention.

FIG. 2 shows a plot of content clustering according to the present invention.

FIG. 3 shows a functional diagram for evaluating annotations to content according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

For convenience purposes, the Detailed Description of the Invention will have the following sections:

I. Computerized Implementation

II. Annotation Evaluation
A. Syntactic Level Evaluation
B. Semantic Level Evaluation
C. Source Level Evaluation
D. Content Level Evaluation
E. Annotator Level Evaluation

III. Additional Implementations

I. Computerized Implementation

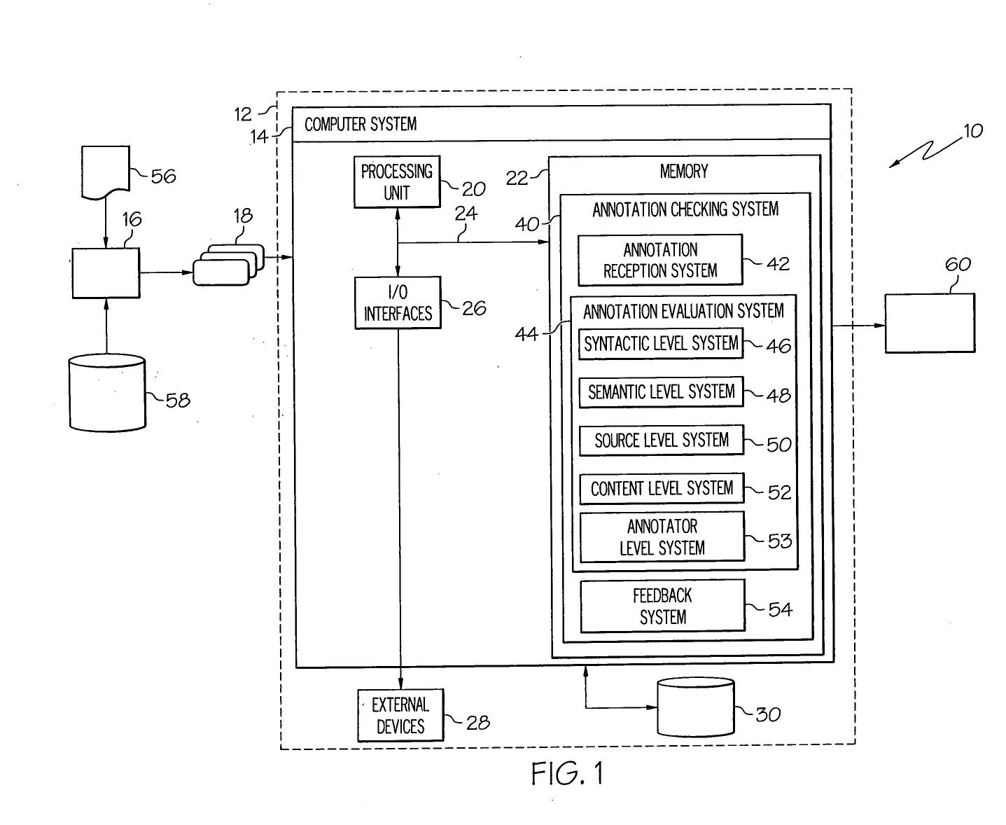

Referring now to FIG. 1, a system 10 for evaluating annotations 18 made to content 56 according to the present invention is shown. Specifically, FIG. 1 depicts a system 10 in which a set (e.g., one or more) of annotations 18 made to content 56 by an annotator 16 can be evaluated and improved. It should be understood in advance that although in an illustrative example, content 56 comprises a news story, this need not be the case. In addition, annotator 16 can be a human Ontologist, a computer program, or a human Ontologist working with a computer program.

In any event, as depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc., or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to evaluate annotations.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as annotation checking system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention, such as set of annotations 18, one or more pieces of content 56, evaluation results, feedback 60, etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is annotation checking system 40. As depicted, annotation checking system 40 includes annotation reception system 42, annotation evaluation system 44 and feedback system 54. Further, annotation evaluation system 44 includes syntactic level system 46, semantic level system 48, source level system 50, content level system 52 and annotator level system 53. In a typical embodiment, annotator 16 will make a set (e.g., one or more) of annotations 18 to content 56. This can be done using data/information (e.g., previous annotations, annotation rules, etc.) from knowledge base 58. The present invention will evaluate set of annotations 18 and provide feedback 60 to guide annotator 16, and/or to update knowledge base 58 for improved future annotations.

In general, set of annotations 18 describe content 56 or individual segments thereof. That is, each of'set of annotations 18 includes at least one element (e.g., a concept or term) that is descriptive of content 56. For example, if content 56 is a video news story about Muhammad Ali, content 56 could have the annotations “boxing”, “Muhammad”, and/or “Ali”. Moreover, the annotations can be specific (like “Ali”) or general (like “human”, “moving”). What is a permitted annotation is determined by consistent rules, exercised by annotator 16. The practice of annotation is known as Ontology and will not be discussed in significantly greater detail herein. However, annotator 16 will annotate piece content 56 using a lexicon of established terms or concepts. Shown below are illustrative terms/concepts with which content can be annotated:

Events: Person-Action (e.g., Monologue [News-Subject-Monologue], Sitting, Standing, Walking, Running, Addressing); People-Event (e.g., Parade, Picnic, Meeting); Sport-Event (Baseball, Basketball, Hockey, Ice-Skating, Swimming, Tennis, Football, Soccer); Transportation-Event (e.g., Car-Crash, Road-Traffic, Airplane-Takeoff, Airplane-Landing, Space-Vehicle-Launch, Missile-Launch); Cartoon; Weather-News; Physical-Violence (e.g., Explosion, Riot, Fight, Gun-Shot).

Scenes: Indoors (e.g., Studio-Setting, Non-Studio-Setting [House-Setting, Classroom-Setting, Factory-Setting, Laboratory-Setting, Meeting-Room-Setting, Briefing-Room-Setting, Office-Setting, Store-Setting, Transportation-Setting]); Outdoors (e.g., Nature-Vegetation [Flower, Tree, Forest, Greenery], Nature-NonVegetation [Sky, Cloud, Water-Body, Snow, Beach, Desert, Land, Mountain, Rock, Waterfall, Fire, Smoke], Man-Made-Scene [Bridge, Building, Cityscape, Road, Statue]); Outer-Space; Sound (e.g., Music, Animal-Noise, Vehicle-Noise, Cheering, Clapping, Laughter, Singing).

Objects: Animal (e.g., Chicken, Cow); Audio (e.g., Male-Speech, Female-Speech); Human (e.g., Face [Male-Face: Bill-Clinton, Newt-Gingrich, Male-News-Person, Male-News-Subject], [Female-Face: Madeleine-Albright, Female-News-Person, Female-News-Subject], Man-Made-Object (e.g., Clock, Chair, Desk, Telephone, Flag, Newspaper, Blackboard, Monitor, Whiteboard, Microphone, Podium); Food; Transportation (e.g., Airplane, Bicycle, Boat, Car, Tractor, Train, Truck, Bus); Graphics-And-Text (e.g., Text-Overlay, Scene-Text, Graphics, Painting, Photographs).

It should be understood that if a software program is used for making set of annotations 18, the software program can be programmed to analyze content to recognize concepts, and to annotate content 56 based on the recognized concepts using an applicable lexicon (e.g., as stored in knowledge base 58). It can further be programmed with other logic applicable to annotation, concept clustering, collocation, and/or information gain, which will be improved using feedback 60 provided under the present invention. For example, for each pair of concepts, X and Y, content annotator 16 could form a two-by-two contingency table for the occurrence of X and Y within the same “shot”, and then compute H(table)−H(rows)−H(columns), where H(.) is an entropy function. In this case, extreme values could signal collocations. For “avoidant” concepts, point-wise mutual information, I(X;Y)=H(X)−H(X|Y) could be used. If this value is negative, it indicates that knowing that concept X appears within a “shot” decreases the likelihood that Y also appears. In addition, information gain for each concept could be defined under the present invention by the binarization Gain(S,C)=H(S)−(|Sp|/|S|)H(Sp)−(|Sn|/|S|)H(Sn), where S is the story, C is the concept, H(.) is entropy, and Sp is the subset of broadcasts positively having the concept C, with Sn defined analogously.

Regardless of the manner in which annotator 16 initially makes set of annotations 18, they will be received or otherwise obtained (e.g., retrieved from storage) by annotation reception system 42 of annotation checking system 40, and passed to annotation evaluation system 44 for evaluation. Under the present invention, set of annotations 18 will be evaluated on a syntactic level and at least one of a semantic level, a source level, a content level, or an annotator level. Each of these levels will be described in Section II below.

II. Annotation Evaluation

Assume in an illustrative example that content 18 is a video news episode/broadcast. Upon receipt of set of annotations 18, annotation evaluation system 44 will perform at least one of the evaluations indicated above. As will be further described below, these evaluations will typically be performed using one or more resources in memory 22 and/or storage system 30.

A. Syntactic Level Evaluation

A first type of evaluation that can be performed under the present invention is a syntactic level evaluation, which is performed by syntactic level system 46. Specifically, a syntactic level evaluation will include one or more of the following components:

(1) A spell check of the element(s) of each of set of annotations 18 using a concept vocabulary or the like (e.g., stored in storage system 30). In a typical embodiment, the concept vocabulary can be specified as an extensible markup language (XML) tree or any other suitable format.

(2) A grammar check to ensure that all annotations follow a pre-specified grammatical form and/or include any required element(s). For example, an annotation rule could specify that each annotation must have at least one object concept, one event concept, and one setting concept, or that each element of the annotations must include a setting concept to the most specific degree of detail. For example, assume that an annotation includes the elements of “Hockey, Outdoors, Clock, and Graphics.” This would satisfy the above illustrative annotation rule as it includes one event, one scene, two objects, according to the concept vocabulary. However, an annotation including the elements of “Hockey, Physical-Violence” would be disallowed as it includes two events, no scene, and no object.

The annotation rules can be specified by “Backus Normal Form” rules (BNF rules), for example: <annotation>::=<event>⁺<scene>⁺<object>⁺ where the plus sign indicates that one or more of these concept classes are necessary. Alternatively, another annotation rule may focus exclusively on events: <annotation>::=<event>², which means that each annotation must have exactly two event concepts, and no scene or object concepts.

(3) A “production value” monitor to ensure that each element of each annotation is described in terms of its production values, such as indoor/outdoor or anchor/reporter.

(4) A new-concept checker that uses a grammar to limit the length of concept names/elements to meet any length requirement(s), and to identify if new concepts are just simple conjunctions of old ones, such as “x_doing_y”. Such concepts could be split into components. “New” concepts are any concepts not already specified in the concept vocabulary. These new concepts can be of any level of specificity. For example, “Rowing” can be a new concept that is an elaboration of the existing “Sport-Event” concept, but “Economic-Event” can be a concept that is completely new to the “Event” concept class.

B. Semantic Level Evaluation

Another type of evaluation provided by the present invention is a semantic level evaluation, which is performed by semantic level system 48. On the semantic level, the system uses an analogy that maps video concepts into the technology of Natural Language Processing (NLP): video shots are like paragraphs, video labels are like words, entire video broadcasts are like documents describable by their body of words, and the classification of video broadcasts is like the classification of documents into classes. The major difference is that video concepts tend to be sparse, relative to the usual word vocabulary size. However, over time, this video concept vocabulary is retained by the tool in a database or the like, and it grows and becomes more refined over time, particularly growing with concepts for specific named objects, events, or settings (e.g., “Bill Clinton”). One existing system used by CNN has such a database; it has 400K concepts, 90% of them named entity concepts. In addition to this retained database, semantic level system 48 utilizes one or more of the following:

(1) A monitoring method to determine if the choice of concepts that annotator 16 selects follow the NLP observation of Zipf's law. Specifically, Zipf's law states that there is often an unequal distribution of sizes of objects, such as the population of cities. It says that if you sort these sizes, the largest is twice as big as the second largest, and three times as big as the third largest, etc. (New York City, Los Angeles, and Chicago do approximately fit). In general, though, this is only after a great deal of movement has been allowed to happen. The usage of words in a document follow this distribution, as there has been a lot of movement of meaning in and out of English words, so that the most common words tend to have a lot of meaning and a lot of use (and tend to be shorter: the word “set” has 120 meanings). This can also mean that any long session of annotation should show that the concepts that are used follow this law. In particular, “People-Event” is the most popular annotation for news stories. Violation of this decreasing population law indicates that annotator 16 probably erred.

To this extent, semantic level system 48 can, among other things, determine whether the element(s) in set of annotations 18 meet an expected frequency of use. This method provides feedback 60 indicating if the annotator is using concepts that are too heavily generic, or (less likely) the opposite. This feedback 60 discourages the use of very high level concepts, like “people”. It suggests for each overused concept some alternatives, driving the annotation more towards specificity. It never suggests a more generic, or “upward propagated” concept instead. In particular, it limits the amounts of “production value” concepts that the annotator can use.

(2) A monitoring method that uses the database to determine if the concepts used by annotator 16 are ones that tend to co-occur in pairs or triplets (like “blue”, “sky”); these are called “collocations”. That is, semantic level system 48 can determine whether any groupings of the element(s) in each of the set of annotations are commonly used together. It does this via the application of a G2 metric. Simultaneously, it determines if any concepts are antagonistic (“indoor”, “tansportation”). It does this by computing negative mutual information. Collocations tend to suggest that the two concepts should be replaced by a single inclusive concept, and antagonistic pairs suggest errors. In either case, the system prompts the annotator for clarification. An example of collocation is “Dow Jones Industrial Average”. Examples of antagonist elements include concepts rarely or never used together such as “Dow Jones Industrial Product” or “Dow Jones Industrial Sum”. These four words are just one concept. Similarly, the phrase “throw in the towel” includes known collocations, while the phrase “throw in the washcloth” appears to be antagonistic. It has also been found that “Male-Speech” avoids “Female-Face”; and “Female-Speech” avoids “Sport-Event”. That is, it appears that these pairs should rarely be used together in the same annotation. Set of annotations 18 can also be evaluated for use of such avoidant elements.

C. Source Level Evaluation

Another type of evaluation provided by the present invention is a source-based evaluation, which is performed by source level system 50. Among other things, a source level evaluation determines whether the element(s) in each of set of annotations 18 matches a ♭temporal setting” (e.g., seasonality, an expected shelf-life, etc.) of content 56, and determines whether the element(s) in each of the set of annotations is reflective of a provider of the content. Specifically, source level system 50 will utilize one or more of the following:

(1) An understanding of the seasonality of some concepts as a check on set of annotations 18. For example, sports concepts vary with the time of year (e.g., when golf is at peak popularity, football is not). By reference to the calendar metadata of the video, the more appropriate concepts can be determined, and annotator 16 can be queried if these temporal expectations are not met. This more specialized database of time dependencies can be determined off-line, by processing the full video annotation database by looking for temporal clusters.

(2) A general understanding of the “shelf life” of content 56, whose rates of reappearance in the news, decays inversely proportional to the length of time that have elapsed from a prior broadcast of the same story. That is, the probably of re-occurrence is 1/(gap+1), where gap is measured in days; according to this model, 85% of broadcast recurrences occur within 2 days. This enables the system to check whether annotator 16 has annotated a completely new story, or one broadcast in a recent series of “fresh” broadcasts that are still active, or a follow-up broadcast of an older story after a space of some time. This determination is used in the content level evaluation to be discussed below.

(3) Channel-specific models of story development, which notes that some services, such as CNN, tend to repeat short broadcasts within the same day, and others, such as ABC, tend to favor single-use longer stories. By recording these channel-specific temporal parameters, the confidence with which a broadcast is considered new, fresh, or old, is computed more precisely.

D. Content Level Evaluation

Another type of evaluation provided by the present invention is a content level evaluation, which is performed by content level system 52. Among other things, the clustering provided by the content level evaluation locates other content that is related (e.g., similar to) to content 56 based on set of annotations 18, and clusters content 56 and the newly located content. Under the present invention, content that is deemed to be similar should have similar annotations. Specifically, in performing the content level evaluation, content level system 52 will apply the following:

(1) A series of algorithms to locate similar units in its database and compare them to the completed unit. Specifically, content level system 52 filters out all but the most specific, highest information gain concepts from the completed unit, and then using a Dice similarity measure (e.g., which compares only those concepts which are actually used) and a computed Laplacian eigenmap of reduced concept dimension, locates several similar units. (In the video news domain, it appears that the first dimension in this reduced dimensional eigenmap roughly corresponds to one in which video broadcasts regarding the President are contrasted to video broadcasts regarding sports or other outdoor events). These similar archival units are presented to annotator 16 to verify if the general themes of the new unit are appropriate. Given that the temporal model can also indicate how new or repetitive some units are, new units are asked to be confirmed, but repetitive ones are checked for consistency with prior units.

In general, the similarity of two pieces of content (e.g., broadcasts “A” and “B”) for clustering purposes can be measured with the following algorithm:
(Dice(i,j)*S)*(Vb)/(d+1)
where Dice(i,j) is a Dice metric borrowed from information retrieval in which “i” refers to broadcast “A” and “j” refers to broadcast “B”; S is a source characteristic value related to the source of the pieces of content; Vb is a following day re-visitation value for the content source of broadcast “B”, and d is the amount of time (e.g., in days) between the showing of broadcasts “A” and “B”.

More specifically, Dice(i,j) is the Dice metric borrowed from Information Retrieval: each broadcast is considered to be a vector of binary presences or absences of visual concepts. To this extent, Dice(i,j) is content similarity value between broadcasts “A” and “B”. It should be understood that Dice is one of many content similarity computations that could be used under the present invention. Others include: “Jaccard”, “Simpson”, “Otsuka”, “Cosine”, etc. Regardless, the following algorithm can be applied to determine Dice:
2a/(2a+b+c)
where a is the count of concepts appearing in both broadcasts “A” and “B” b is the count of concepts present in broadcast “A” but not broadcast “B”, and c is the count of concepts appearing in broadcast “B” but not broadcast “A”. Fully matching pieces of content will have content similarity value of one. This value will decrease as the pieces of content become more dissimilar.

(2) These algorithms also highlight those concepts in the completed unit which are rare or new concepts; such concepts tend to co-occur solely within a unit and can be detected by mutual information measures. The system then poses annotator 16 the question: “Is this video story about the following unusual objects/events/settings?” Conversely, if there are many units that match the completed one, but no rare or new concepts, it prompts annotator 16 to provide more distinguishing concepts in the annotation, so that the unit is specified to a more proper level of uniqueness.

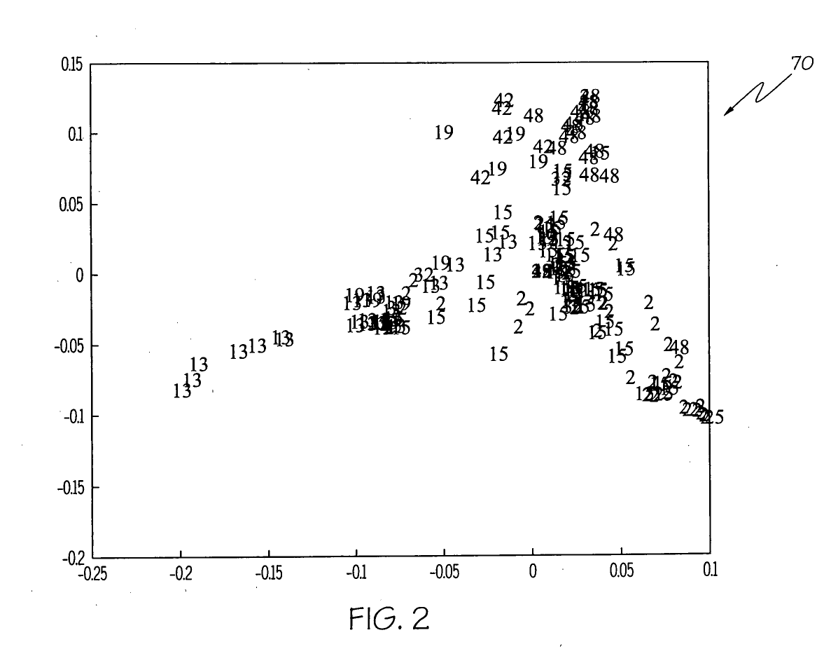

Referring to FIG. 2, a plot 70 of content clustering according to the present invention is shown. Specifically, the numbers in FIG. 2 refer to specific news broadcasts. The clusters in FIG. 2 represent broadcasts that were determined to be related to one another. As indicated above, broadcasts that are determined to be similar should have similar annotations.

E. Annotator Level Evaluation

Another type of evaluation provided by the present invention is an annotator level evaluation, which is performed by annotator level system 53. Specifically, annotator level system 53 will maintain a database of terms used by each specific annotator, and apply a series of algorithms to determine if any terms used by an annotator are unique to the annotator him/herself. Such idiosyncrasies work against efficient and effective indexing. Annotator level system 53 will then ask if there are any terms that can replace the unique terms, iterating this process until it becomes statistically unlikely that the single annotator's work can be recognized on the basis of idiosyncratic annotations.

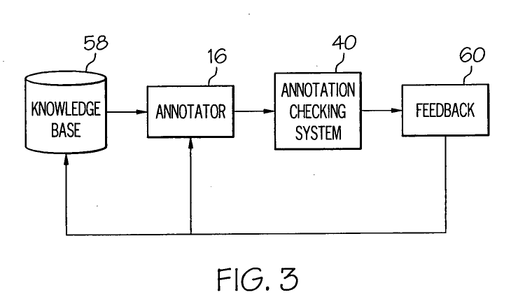

In any event, once these evaluation(s) have been performed, feedback system 54 will provide corresponding feedback 60 to annotator 16 who will use feedback 60 to improve set of annotations 18 as well as any future annotations. In addition, feedback can be used to improve knowledge base 58. This is shown more specifically in FIG. 3. Feedback 60 should be understood to take any form. For example, feedback 60 can include evaluation results, instructions, questions, comments, etc.

III. Additional Implementations

While shown and described herein as a method and system for evaluating annotations to content, it is understood that the invention further provides various alternative embodiments. For example, in one embodiment, the invention provides a computer-readable medium (or computer useable medium) that includes computer program code to enable a computer infrastructure to evaluate annotations to content. To this extent, the computer-readable medium or computer useable medium includes program code that implements each of the various process steps of the invention. It is understood that the term “computer-readable medium” or “computer useable medium” comprises one or more of any type of physical embodiment of the program code. In particular, the or computer-readable medium or computer useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to evaluate annotations to content. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for evaluating annotations to content. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A computer-implemented method for evaluating annotations to content, comprising:
receiving a set of annotations for content, wherein each of the set of annotations includes at least one element that describes the content;
performing a syntactic level evaluation and at least one of a semantic level evaluation, a source level evaluation, a content level evaluation, or an annotator level evaluation to determine accuracy of the set of annotations; and
providing feedback based on the evaluations.

2. The computer-implemented method of claim 1, wherein the syntactic level evaluation comprises:
determining whether the set of annotations includes a required element based on a context of the content;
checking a spelling of the at least one element in each of the set of annotations; and
determining whether the at least one element in each of the set of annotations meets a length requirement.

3. The computer-implemented method of claim 1, wherein the semantic level evaluation comprises:
determining whether the at least one element in the set of annotations meets with an expected frequency of use; and
determining whether any groupings of the at least one element in each of the set of annotations are commonly used together or are rarely used together.

4. The computer-implemented method of claim 1, wherein the source level evaluation comprises:
determining whether the at least one element in each of the set of annotations matches a temporal setting of the content; and
determining whether the at least one element in each of the set of annotations is reflective of a provider of the content.

5. The computer-implemented method of claim 1, wherein the content level evaluation comprises:
locating other content that is related to the content based on the set of annotations; and
clustering the content and the other content.

6. The computer-implemented method of claim 1, wherein the annotator level evaluation comprises:
determining whether the at least one element includes an element that is unique to a particular annotator; and
identifying a new element to replace the element.

7. A system for evaluating annotations to content, comprising:
an annotation reception system configured to receive a set of annotations for content, wherein each of the set of annotations includes at least one element that describes the content;
an annotator evaluation system configured to perform a syntactic level evaluation and at least one of a semantic level evaluation, a source level evaluation, a content level evaluation, or an annotator level evaluation to determine accuracy of the set of annotations; and
a feedback system configured to provide feedback based on the evaluations.

8. The system of claim 7, wherein the syntactic level evaluation determines whether the set of annotations includes a required element based on a context of the content, checks a spelling of the at least one element in each of the set of annotations, and determines whether the at least one element in each of the set of annotations meets a length requirement.

9. The system of claim 7, wherein the semantic level evaluation determines whether the at least one element in the set of annotations meets with an expected frequency of use, and determines whether any groupings of the at least one element in each of the set of annotations are commonly used together.

10. The system of claim 7, wherein the source level evaluation determines whether the at least one element in each of the set of annotations matches a temporal setting of the content, and determines whether the at least one element in each of the set of annotations is reflective of a provider of the content.

11. The system of claim 7, wherein the content level evaluation locates other content that is related to content based on the set of annotations, and clusters the content and the other content.

12. The system of claim 7, wherein the annotator level evaluation determines whether the at least one element includes an element that is unique to a particular annotator, and identifies a new element to replace the element.

13. The system of claim 7, wherein the feedback is provided to an annotator to guide the creation of the set of annotations

14. A program product stored on a computer useable medium for evaluating annotations to content, the program product comprising program code for causing a computer system to perform the following functions:
receiving a set of annotations for content, wherein each of the set of annotations includes at least one element that describes the content;
performing a syntactic level evaluation and at least one of a semantic level evaluation, a source level evaluation, a content level evaluation, or an annotator level evaluation to determine accuracy of the set of annotations; and
providing feedback based on the evaluations.

15. The program product of claim 14, wherein the syntactic level evaluation determines whether the set of annotations includes a required element based on a context of the content, checks a spelling of the at least one element in each of the set of annotations, and determines whether the at least one element in each of the set of annotations meets a length requirement.

16. The program product of claim 14, wherein the semantic level evaluation determines whether the at least one element in the set of annotations meets with an expected frequency of use, and determines whether any groupings of the at least one element in each of the set of annotations are commonly used together.

17. The program product of claim 14, wherein the source level evaluation determines whether the at least one element in each of the set of annotations matches a temporal setting of the content, and determines whether the at least one element in each of the set of annotations is reflective of a provider of the content.

18. The program product of claim 14, wherein the content level evaluation locates other content that is related to content based on the set of annotations, and clusters the content and the other content.

19. The program product of claim 14, wherein the annotator level evaluation determines whether the at least one element includes an element that is unique to a particular annotator, identifies a new element to replace the terms.

20. A method for deploying an application for evaluating annotations to content, comprising:
providing a computer infrastructure being operable to:
receive a set of annotations for content, wherein each of the set of annotations includes at least one element that describes the content;
perform a syntactic level evaluation and at least one of a semantic level evaluation, a source level evaluation, a content level evaluation, or an annotator level evaluation to determine accuracy of the set of annotations; and
provide feedback based on the evaluations.
